(19) United States
(12) Patent Application Publication
(10) Pub. No.: US 2026/0121419 A1
(43) Pub. Date: Apr. 30, 2026

(54) GREEN POWER-CONSUMPTION FOR EDGE DEVICES

(71) Applicant: Dell Products L.P., Round Rock, TX (US)

(72) Inventors: Tomer Shachar, Beer-Sheva (IL); Yevgeni Gehtman, Modi’in (IL); Sarah Evans, Parker, CO (US)

(21) Appl. No.: 18/925,483

(22) Filed: Oct. 24, 2024

(51) Int. Cl. H02J 7/35

(52) U.S. Cl. CPC H02J 7/35; H02J 2101/22

(57) ABSTRACT

A computing system configured with a sustainability system is disclosed. A sustainability engine is configured to direct non-core activities of a computing system to a data processing unit and core-activities of the computing system to a central processing unit. The data processing unit is powered using a free energy power source. Depending on capability or status of the free energy power status, power for the data processing unit may be switched to a different power source as needed. This is achieved while allowing resource intensive security capabilities to be improved while advancing sustainability goals.

### TECHNOLOGICAL FIELD OF THE DISCLOSURE

Embodiments disclosed herein generally relate to sustainability in computing systems and devices and operation thereof. More particularly, at least some embodiments relate to systems, hardware, software, computer-readable media, and methods for increasing security in computing systems and devices in sustainability aware manner.

### BACKGROUND

Generally, sustainability refers to the ability to sustain operations over time. Sustainability can be viewed from various perspectives, including economic, environmental, and social perspectives. In order to address sustainability concerns, many entities and businesses have set sustainability goals (e.g., sustainability and governance (ESG) goals).

One of the ways in which these goals is achieved by relates to power generation and power consumption. Efforts to consume power sustainably include relying more on green or renewable energy sources. Using green or renewable energy sources benefits the environment and promotes sustainability at least by reducing carbon emissions.

Sustainability goals, however, may not always align with business goals. For example, entities involved in manufacturing/selling/servicing computing systems and devices have strong incentives to provide and promote security and reliability. However, many security related processes/operations are viewed as heavy consumption activities. Processes, such as cryptography operations, require more CPU (central processing unit) usage. This, in turn, increases power consumption and power requirements.

Security (or other processes performed in computing systems/devices) often increase power consumption and power requirements at a time when there is a desire to achieve sustainability goals. The ability to set and meet sustainability goals may also be influenced by the goals of customers and vendors, who may be more likely to purchase from vendors that are striving to improve sustainability.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings, in which:

FIG. 1 discloses aspects of a computing environment and of a sustainability engine operating in the computing environment;

FIG. 2 discloses aspects of a method for performing sustainability operations in a computing system;

FIG. 3 discloses aspects of a sustainability system or engine configured to deliver free energy to components of a computing system;

FIG. 4 discloses additional aspects of a sustainability system or engine for delivering energy to components of a computing system; and

FIG. 5 discloses aspects of a computing device, system, or entity.

### DETAILED DESCRIPTION OF SOME EXAMPLE EMBODIMENTS

Embodiments disclosed herein generally relate to increasing product/system security in a sustainability aware manner. More particularly, at least some embodiments relate to systems, hardware, software, computer-readable media, and methods for achieving or improving sustainability in computing related activities including, but not limited to, manufacture, deployment, applications, services, storage, and/or operation.

More specifically, embodiments of the invention relate generally to providing security in computing systems while also reducing the impact of providing security on energy consumption, costs, and the environment.

Embodiments are discussed in the context of processing units, such as central processing units (CPUs) and data processing units (DPUs). Both CPUs and DPUs may include processors, memory, and other circuitry. While both can handle a variety of computing related tasks, DPUs are typically configured or specialized for handing workloads that are data-focused. Thus, DPUs may be able to complete data-centric tasks more quickly and efficiently than CPUs. Example workloads for DPUs include security workloads, storage management workloads, networking workloads, and the like. Further, power requirements for DPUs are generally lower compared to power requirements of CPUs. It may be advantageous, from a power perspective, to direct a workload to a DPU when possible.

Heavy consumption activities, including those for security processes (e.g., mathematical calculations, cryptography) require CPU usage, which consequently results in increased power consumption. Adding security processes to a workflow may increase power requirements. For example, adding cryptography activities (e.g., encrypting, decrypting) to a process or workflow places an additional load on the CPU. This increases the CPU cycles, which requires electricity and thus has a sustainability impact.

While improving security has advantages, the increase in energy consumption is often contrary to sustainability (e.g., ESG) goals. Embodiments of the invention relate to increasing product/service security while accelerating an economy that protects the environment and improves sustainability. Embodiments may be discussed in the context of security related operations, but can be adapted to other scenarios.

For example, security can be improved by implementing zero-trust principles. Zero-trust principles, by way of example, may include giving workloads an identity and controlling east-west workload communications across multi-cloud environments by policy. In some examples, workload identity is achieved using SPIFFE/SPIRE and policies are implemented using Open Policy Agent (OPA). In addition, an Envoy proxy may be used as a policy decision point (PDP) and policy enforcement point (PEP). Implementing zero-trust principles, however, often requires additional processing. The additional processing requires power. Thus, implementing zero-trust principles may have an adverse impact from a sustainability perspective.

In one example, each workload’s identity was validated through increased encryption and additional policy checks were put in place prior to workloads moving and communicating across an environment. These security improvements, by way of example, placed an increased load on the underlying system CPU and resulted in increased power consumption.

Embodiments of the invention are related to increasing/improving security and improving sustainability. This is achieved, in one example, by equipping a computing system with a sustainability system that includes a sustainability engine. The sustainability system may

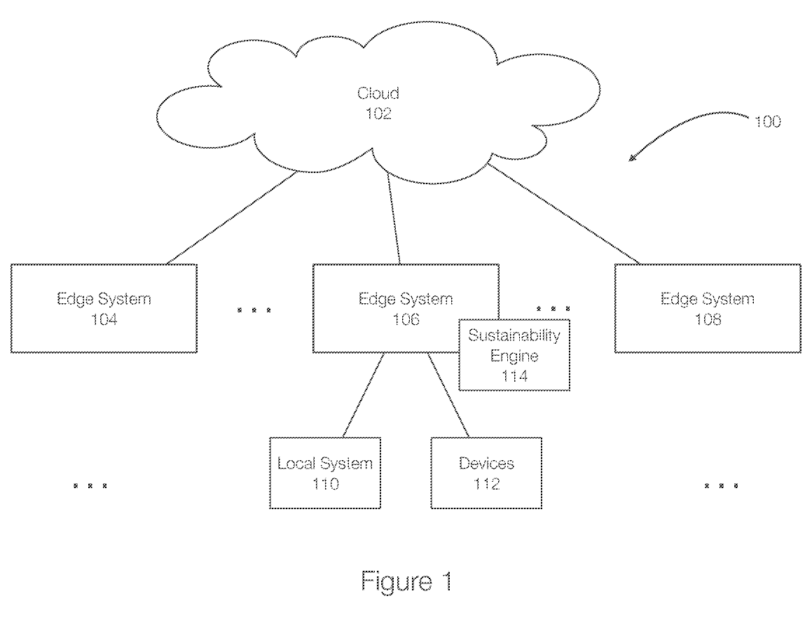

FIG. 1 discloses aspects of a computing environment in which sustainability operations may be implemented. FIG. 1 generally illustrates computing systems 100 at multiple levels. The cloud 102 represents computing equipment, datacenters, server clusters, and the like that are generally located remote from end users. The computing resources available in the cloud 102 can be used for storage, applications, and the like.

Another level of computing is represented by edge systems 104, 106, and 108. Edge systems, in one example, may provide cloud-like resources (at a smaller scale) and are typically closer to the users/clients/customers. For example, the edge system 106 may include processing, storage, network hardware, and the like. Edge systems may be related (distributed). Because edge systems are typically closer to consumers, applications may be executed more efficiently.

Each edge system be connected or capable of connecting with local systems (e.g., local system 110) and other devices 112. Examples of devices 112 include customer equipment, tablets, smartphones, IoT (Internet of Things) devices such as sensors, and the like. The local system 110 may represent an on-premise system, which may include servers, clients, and other networks such as local area networks (LANs). Communication among systems/devices in the system 100 may include various types of wired/wireless networks, cellular networks, the Internet, LANs, WANs, or the like or combinations thereof.

When applications are performed in the systems 100 of FIG. 1, security is a concern and implementing security within and/or between systems can have a measurable impact on power consumption and on the environment.

Embodiments of the invention are discussed in the context of the edge system 106, but may be implemented in the cloud 102, multiple clouds, multiple edge systems, multiple local systems, or the like.

FIG. 1 illustrates that the edge system 106 is associated with a sustainability engine 114. The sustainability engine 114 is configured to improve sustainability while also facilitating security operations (and/or other operations). The sustainability engine 114 may include various components that may be integrated into a device, a server, a switch, or elsewhere. More generally, the sustainability engine 114 may be implemented to operate with power supplies and to connect free-energy power sources to component power supplies.

The sustainability engine 114 is generally configured to separate core activities from non-core activities. Core activities may be assigned to CPU while non-core activities may be assigned to DPU. The determination of whether a particular activity is a core activity or a non-core activity may be determined by an administrator, by default, based on expected or anticipated CPU requirements, based on historical consumption, which may include a model configured to classify an activity as core or non-core, or the like or combinations thereof.

More specifically, the definition of core activities and non-core activities may vary and may depend on context. For example, processes or activities that tend to be CPU intensive or electricity-hungry may be deemed to be non-core activities. In one example, heavy consumption activities (e.g., security related compute functions) are deemed non-core activities and may be processed in a dedicated DPU. Moving these activities to from a CPU to a DPU can reduce the impact (e.g., overheating, overclocking, over-cycling/fatigue) of these activities on the CPU and ensure that the CPU has more availability.

DPUs are often configured for operations including network tasks such as packet processing, packet routing, while CPU may be more suited for executing an application’s logic. Data processing units are also suitable for tasks such as compression/decompression, encryption/decryption, and the like that may occur in the context of, for example, authentication, storage, or the like. Data processing units are also suitable for various security related tasks.

In one example the data processing unit may be configured to operate using free-energy. Free energy refers, by way of example only, to renewable energy sources (e.g., solar, wind, geothermal, biofuel, hydropower) or to energy sources that are environmentally friendly.

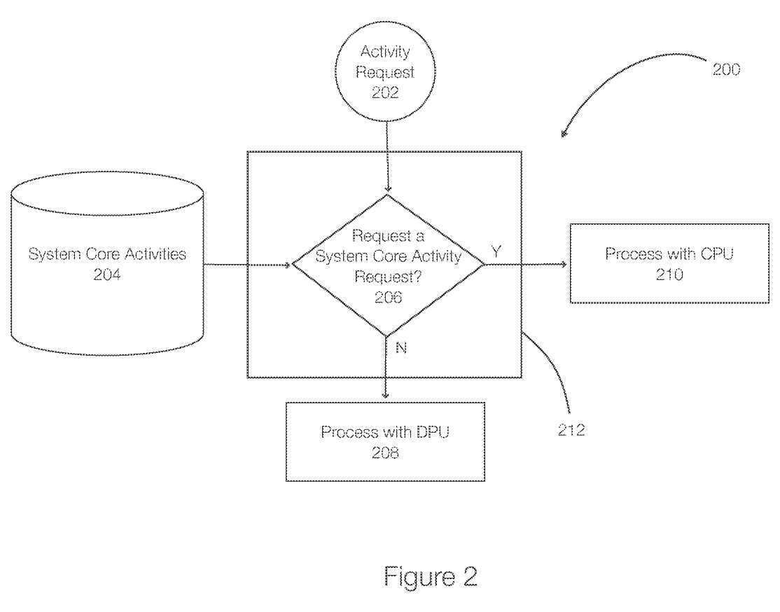

FIG. 2 discloses additional aspects of a sustainability engine configured to improve sustainability in computing environments and workload executions. The sustainability engine may be placed in a computing system such that activities that require CPU or DPU can be detected. When detected, this allows the activity to be directed to the appropriate processing unit.

FIG. 2 illustrates aspects of a method 200 that may be performed by a sustainability engine 212. In this example, a request (activity) 202 is received or identified by the sustainability engine 212. The sustainability engine 212 may access a system core activities database 204 and determine whether the activity is a core activity or a non-core activity.

If the sustainability engine determines that the request is a core activity (Y at 206), the request is directed to and processed 210 with CPU. If the sustainability engine determines that the request is a non-core activity (N at 206), the request is directed to and processed 208 with DPU.

In this example, the system core activities database 204 allows core activities to be identified by comparing the request with the entries in the database 204. A match indicates, in this example, that the request is a core-activity while a fail of non-match indicates a non-core activity. The activities included in the system core activities database 204 can be defined by an administrator, based on historical CPU usage/power consumption data, manufacturer or publisher recommendations or the like.

In another example, telemetry data regarding a CPU and requests can be generated over time. This telemetry data can be used to train a model that infers whether a request is a core activity or a non-core activity. This may allow the sustainability engine to account for other features or characteristics of the computing system/environment (e.g., CPU cycles, CPU usage, power consumption) when determining whether to classify a request as a core activity or a non-core activity.

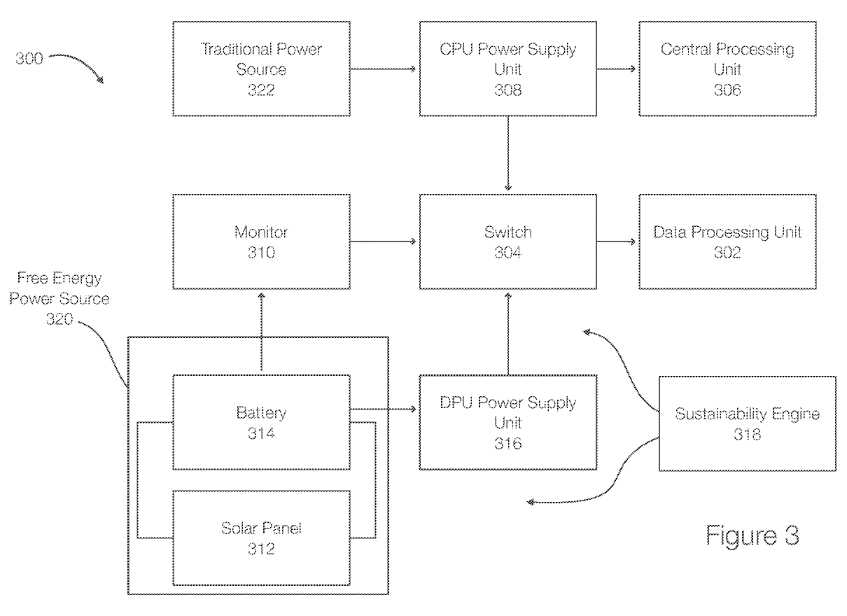

FIG. 3 discloses additional aspects of a sustainability engine and/or methods for executing requests more sustainably. FIG. 3 illustrates a computing system 300 that includes a central processing unit 306 and a data processing unit 302. The central processing unit 306 is powered by a CPU power supply unit 308, which receives power from a traditional power source (e.g., a power grid) 322.

Power for a DPU power supply unit 316 is generated by a free energy power source 320. In this example, the free energy power source 320 includes a rechargeable battery 314 that is charged by a renewable energy source (e.g., solar panel 312). A monitor 310 monitors an energy level of the battery 314. The monitor 310 controls a switch 304.

When the battery 314 has sufficient power, the monitor 310 configures the switch 304 to a first state such that the DPU power supply unit 316, which provides power to the data processing unit 302, is powered by the free energy power source 320. If the energy level of the battery 314 is below a threshold level, the monitor 310 switches the switch 304 to a second state such that the data processing unit 302 is powered by the CPU power supply unit 308, which receives power from the traditional power source 322.

As illustrated in FIG. 3, the power supplied to the data processing unit 302 may come from different sources. The system of FIG. 3 allows security processes (non-core activities) to be performed by a data processing unit 302, which is configured to handle operations or processes deemed to be non-core activities. This reduces adverse impacts on the central processing unit 306 (overheating, overclocking, etc.) and also promotes sustainability by being connected to a free energy power source 320 when possible.

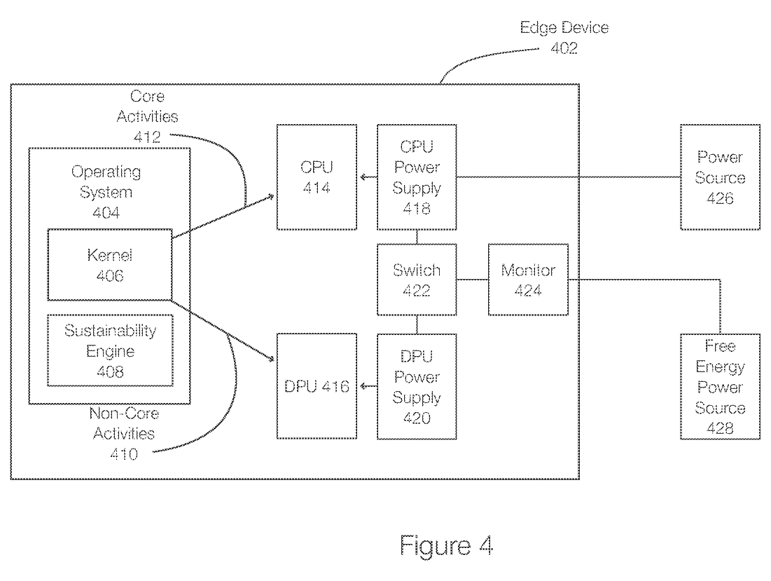

FIG. 4 discloses additional aspects of operating a sustainability engine in a computing system or device. FIG. 4 illustrates a sustainability engine 408 integrated into an edge device 402 (e.g., a server computer). In this example, an operating system 404 operates on the edge device 402 and the kernel 406 may generate requests, events, calls, commands (generally referred to as activities). The sustainability engine 408 may cause core activities 412 to be directed to a CPU 414 and non-core activities to be directed to a DPU 416.

Generally, the DPU power supply 420, which powers the DPU 416, receives power from a free energy power source 428 and the CPU power supply 418, which powers the CPU 414, receives power from a power source 426. The monitor 424 controls a switch 422 and monitors an energy level of the free energy power source 428. When the energy level is too low or below a threshold level (e.g., 10%), the monitor switches the switch 422 to a different state such that the DPU power supply 420 is powered by the power source 426. In this example, each processing unit (CPU 414 and DPU 416) is associated with its own power supply.

In other examples, the free energy power source 428 may provide power to both the CPU power supply 418 and the DPU power supply 420 and power from the power source 426 is accessed only when needed or during a recharge cycle at the free energy power source 428. In one example, times of lower energy usage may be identified or predicted. At times of lower energy usage, the sustainability engine 408 may allow the free energy power source 428 to recharge in anticipation of higher power requirements. In some examples, the manner in which power is supplied to the edge device 402 may depend on the capability or energy capacity of the free energy power source 428.

Further, the configuration of the free energy power source 428 may vary. In the case of solar panels, energy may be delivered directly from the solar panels. When solar energy is not directly available, secondary battery power (charged by the solar panel) may be used.

In one example, the sustainability engine may include multiple components (e.g., an operating system component and a monitor). The sustainability engine 408 may receive updates from the monitor 424. Alternatively, the monitor 424 may be configured to change the switch 422 based on data from the free energy power source 428

It is noted that embodiments disclosed herein, whether claimed or not, cannot be performed, practically or otherwise, in the mind of a human. Accordingly, nothing herein should be construed as teaching or suggesting that any aspect of any embodiment could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

The following is a discussion of aspects of example operating environments for various embodiments. This discussion is not intended to limit the scope of the claims or this disclosure, or the applicability of the embodiments, in any way.

In general, embodiments may be implemented in connection with systems, software, and components, that individually and/or collectively implement, and/or cause the implementation of, power source related operations, power source selection operations, sustainability operations, security operations, power supply switching operations, power source monitoring operations, activity determination operations, activity delivery operations, or the like or combinations thereof. More generally, the scope of this disclosure embraces any operating environment in which the disclosed concepts may be useful.

New and/or modified data collected and/or generated in connection with some embodiments, may be stored in a data storage environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter, an edge system, an on-premise system, or the like, which is operable to perform operations initiated by one or more clients or other elements of the operating environment.

Example cloud computing environments, which may or may not be public, include storage environments that may provide functionality for one or more clients. Another example of a cloud computing environment is one in which processing, data storage, data protection, and other services may be performed on behalf of one or more clients. Some example cloud computing environments in which embodiments may be employed include Microsoft Azure, Amazon AWS, Dell EMC Cloud Storage Services, and Google Cloud. More generally however, the scope of this disclosure is not limited to employment of any particular type or implementation of cloud computing environment.

In addition to the cloud environment, the operating environment may also include one or more clients capable of collecting, modifying, and creating, data. As such, a particular client or server or other computing system may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data storage system components such as databases, storage servers, storage volumes (LUNs), storage disks, servers and clients, for example, may likewise take the form of software, physical machines, containers, or virtual machines (VMs), though no particular component implementation is required for any embodiment.

As used herein, the term ‘data’ or ‘object’ is intended to be broad in scope. Example embodiments are applicable to any system capable of storing and handling various types of objects, in analog, digital, or other form.

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments. These are presented only by way of example and are not intended to limit the scope of this disclosure or the claims in any way.

Embodiment 1. A method comprising: identifying a request in a computing system by a sustainability engine, determining whether the request is a non-core activity, directing the request to a data processing unit, and controlling a switch connected to a power supply of the data processing to be in a first state such that power is supplied to the power supply of the data processing unit from a first power source when an energy level available from the first power source is greater than a threshold level.

Embodiment 2. The method of embodiment 1, further comprising accessing a database that stores core activities and/or non-core activities to determine whether the request is the non-core activity.

Embodiment 3. The method of embodiment 1 and/or 2, wherein the non-core activity comprises a security process, a storage process, and/or a network process.

Embodiment 4. The method of embodiment 1, 2, and/or 3, wherein the first energy source is a renewable energy source.

Embodiment 5. The method of embodiment 1, 2, 3, and/or 4, wherein the first energy source comprises a renewable energy source and a battery, wherein the battery is charged by the renewable energy source.

Embodiment 6. The method of embodiment 1, 2, 3, 4, and/or 5, wherein the first power source is a solar power source, a hydro power source, a wind power source, a geothermal power source, or a biofuel power source.

Embodiment 7. The method of embodiment 1, 2, 3, 4, 5, and/or 6, further comprising controlling the switch to be in a second state to connect the power supply of the data processing unit to a second power source.

Embodiment 8. The method of embodiment 1, 2, 3, 4, 5, 6, and/or 7, wherein the switch connects the power supply of the data processing unit to a power supply of a central processing unit that is connected to the second power source when the energy level is below the threshold.

Embodiment 9. The method of embodiment 1, 2, 3, 4, 5, 6, 7, and/or 8, further comprising determining that the request is a core activity and directing the request to a central processing unit.

Embodiment 10. The method of embodiment 1, 2, 3, 4, 5, 6, 7, 8, and/or 9, further comprising generating an inference as to whether the request is the non-core activity or a core-activity.

Embodiment 11. The method of embodiment 1, 2, 3, 4, 5, 6, 7, 8, 9, and/or 10, wherein the sustainability engine allows the computing system to be improved with additional processes while reducing an impact of the additional processes while achieving a sustainability goal and/or reducing an impact of the additional processes on a central processing unit.

Embodiment 12. The method of embodiment 1, 2, 3, 4, 5, 6, 7, 8, 9, 10, and/or 11, wherein the sustainability goal includes reducing carbon emissions.

Embodiment 13. A system, comprising hardware and/or software, operable to perform any of the operations, methods, or processes, or any portion of any of these, disclosed herein.

Embodiment 14. A non-transitory storage medium having stored therein instructions that are executable by one or more hardware processors to perform operations comprising the operations of any one or more of embodiments 1-12.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, manager, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

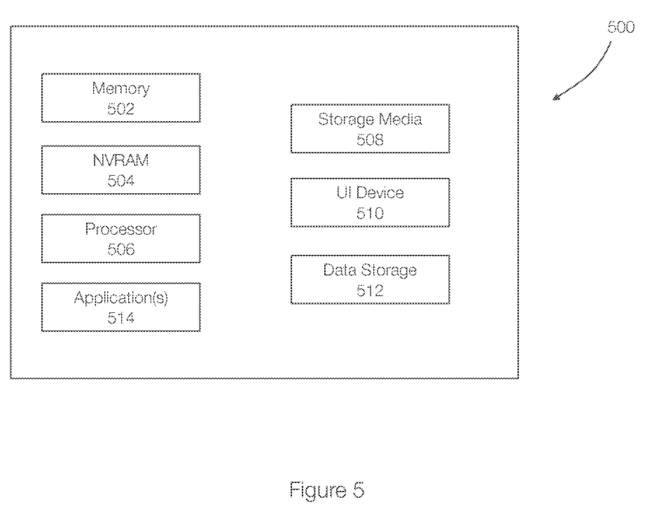

With reference briefly now to FIG. 5, any one or more of the entities disclosed, or implied, by the Figures and/or elsewhere herein, may take the form of, or include, or be implemented on, or hosted by, a physical computing device, one example of which is denoted at 500. As well, where any of the aforementioned elements comprise or consist of a virtual machine (VM), that VM may constitute a virtualization of any combination of the physical components disclosed in FIG. 5.

In the example of FIG. 5, the physical computing device 500 includes a memory 502 which may include one, some, or all, of random access memory (RAM), non-volatile memory (NVM) 504 such as NVRAM for example, read-only memory (ROM), and persistent memory, one or more hardware processors 506, non-transitory storage media 508, UI device 510, and data storage 512. One or more of the memory components 502 of the physical computing device 500 may take the form of solid state device (SSD) storage. As well, one or more applications 514 may be provided that comprise instructions executable by one or more hardware processors 506 to perform any of the operations, or portions thereof, disclosed herein.

The device 500 may also represent a computing system such as a server or set of servers, an edge based computing system, a cloud-based computing system, or the like. The computing system may be localized or distributed in nature.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The device 500 may also represent a physical or virtual machine or server, an edge-based computing system, a cloud-based computing system, server clusters or other computing systems or environments. The device 500 may also represent multiple machines or devices, whether virtual, containerized, or physical. The device 500 may perform or execute steps or acts of the methods/operations illustrated in the Figures and described herein.

The device 500 may represent a cloud-based system, an edge-based, system, an on-premise system, or combinations thereof. Document understanding and related operations may be performed using these types of computing environments/systems. The device 500 may also represent aspects of a sustainability system or engine.

The described embodiments are to be considered in all respects only as illustrative and not restrictive. All changes which come within the meaning and range of equivalency of the claims are to be embraced within their scope.

What is claimed is:

1. A method comprising:
identifying a request in a computing system by a sustainability engine;
determining whether the request is a non-core activity;
directing the request to a data processing unit; and
controlling a switch connected to a power supply of the data processing to be in a first state such that power is supplied to the power supply of the data processing unit from a first power source when an energy level available from the first power source is greater than a threshold level.

2. The method of claim 1, further comprising accessing a database that stores core activities and/or non-core activities to determine whether the request is the non-core activity.

3. The method of claim 2, wherein the non-core activity comprises a security process, a storage process, and/or a network process.

4. The method of claim 1, wherein the first energy source is a renewable energy source.

5. The method of claim 4, wherein the first energy source comprises a renewable energy source and a battery, wherein the battery is charged by the renewable energy source.

6. The method of claim 5, wherein the first power source is a solar power source, a hydro power source, a wind power source, a geothermal power source, or a biofuel power source.

7. The method of claim 1, further comprising controlling the switch to be in a second state to connect the power supply of the data processing unit to a second power source.

8. The method of claim 7, wherein the switch connects the power supply of the data processing unit to a power supply of a central processing unit that is connected to the second power source when the energy level is below the threshold.

9. The method of claim 1, further comprising determining that the request is a core activity and directing the request to a central processing unit.

10. The method of claim 9, further comprising generating an inference as to whether the request is the non-core activity or a core-activity.

11. The method of claim 1, wherein the sustainability engine allows the computing system to be improved with additional processes while reducing an impact of the additional processes while achieving a sustainability goal and/or reducing an impact of the additional processes on a central processing unit.

12. The method of claim 11, wherein the sustainability goal includes reducing carbon emissions.

13. A non-transitory storage medium having stored therein instructions that are executable by one or more hardware processors to perform operations comprising:
identifying a request in a computing system by a sustainability engine;
determining whether the request is a non-core activity;
directing the request to a data processing unit; and
controlling a switch connected to a power supply of the data processing to be in a first state such that power is supplied to the power supply of the data processing unit from a first power source when an energy level available from the first power source is greater than a threshold level.

14. The non-transitory storage medium of claim 13, further comprising accessing a database that stores core activities and/or non-core activities to determine whether the request is the non-core activity, wherein the non-core activity comprises a security process, a storage process, and/or a network process.

15. The non-transitory storage medium of claim 13, wherein the first energy source is a renewable energy source, wherein the first energy source comprises a renewable energy source and a battery, wherein the battery is charged by the renewable energy source.

16. The non-transitory storage medium of claim 15, wherein the first power source is a solar power source, a hydro power source, a wind power source, a geothermal power source, or a biofuel power source.

17. The non-transitory storage medium of claim 13, further comprising controlling the switch to be in a second state to connect the power supply of the data processing unit to a second power source, wherein the switch connects the power supply of the data processing unit to a power supply of a central processing unit that is connected to the second power source when the energy level is below the threshold.

18. The non-transitory storage medium of claim 13, further comprising determining that the request is a core activity and directing the request to a central processing unit.

19. The non-transitory storage medium of claim 18, further comprising generating an inference as to whether the request is the non-core activity or a core-activity.

20. The non-transitory storage medium of claim 13, wherein the sustainability engine allows the computing system to be improved with additional processes while reducing an impact of the additional processes while achieving a sustainability goal and/or reducing an impact of the additional processes on a central processing unit, wherein the sustainability goal includes reducing carbon emissions.
